(19) United States
(12) Patent Application Publication
(10) Pub. No.: US 2008/0169324 A1
(43) Pub. Date: Jul. 17, 2008

(54) Shirt for simplified child carrying

(76) Inventor: Paul Kang, New York, NY (US)

Correspondence Address: DAY PITNEY LLP, 7 TIMES SQUARE, NEW YORK, NY, 10036-7311, US

(21) Appl. No.: 11/654,088

(22) Filed: Jan. 17, 2007

(51) Int. Cl. A45F 4/00; A61G 99/00; A41D 27/10

(52) U.S. Cl. 224/576; 224/158; 2/243.1

(57) ABSTRACT

A shirt, blouse, jacket, coat or similar article of clothing includes straps on the rearward portion of the sleeves, immediately below the elbow. This allows the adult user to grasp the strap on the left sleeve with the right hand and grasp the strap on the right sleeve with the left hand in order to securely hold a baby or small child and shift the burden from the adult user's biceps to the triceps, hands and wrists.

### BACKGROUND OF THE INVENTION

1. Field of the Invention

The present invention pertains to a shirt with loops on the sleeves for simplified child carrying.

2. Description of the Prior Art

Parents can put a lot of thought into the carrying of babies or young children. Babies can be carried in the parent's arms, on the parent's back or in baby carriers, such as slings or backpacks. However, children usually prefer being carried in the parent's arms. However, this can lead to mental or physical fatigue or exhaustion on the part of the parent.

Additionally, most baby carrying equipment has many of the following disadvantages—the hassle and bother of dealing with equipment (including remembering and not losing the equipment), the weight of the baby is typically supported by the baby's crotch, the equipment is bulky and less than aesthetic, the baby may be carried in a forward orientation, the equipment may require slow or tiresome routines for picking the baby up or putting the baby down, and the equipment may be hot for both the parent and the child. Moreover, some baby carrying equipment is expensive.

### OBJECTS AND SUMMARY OF THE INVENTION

It is therefore an object of the present invention to provide an apparatus for simplified carrying of babies or small children.

It is therefore a further object of the present invention to provide an apparatus to allow the parent or other adult to carry a baby or small child in their arms, so that the adult and child or small child are facing each other, as is typically preferred by the baby or small child.

These and other objects are attained by providing shirt, blouse, jacket or similar article of clothing for the parent, wherein loops are formed adjacent to the elbow areas of both sleeves. This allows the parent to hold the child and grasp the loops with opposite hands (that is, the right hand grasps the loop on the left elbow and the left hand grasps the loop on the right elbow) so as to form a secure place for the child and shifting the burden from the parent's biceps to the triceps, hands and wrists. The child is therefore carried in a position facing the parent. Additionally, the added cost and bulk of this apparatus in minimal, as compared to an ordinary shirt or blouse, and is not likely to be lost or misplaced during use.

### BRIEF DESCRIPTION OF THE DRAWINGS

Further objects and advantages of the invention will become apparent from the following description and from the accompanying drawings, wherein:

FIG. 1 is a front view of the shirt, blouse or similar article of clothing of the present invention.

FIG. 2 is a perspective view of the shirt, blouse or similar article of clothing of the present invention, in use with a child being carried by an adult.

### DETAILED DESCRIPTION OF THE PREFERRED EMBODIMENT

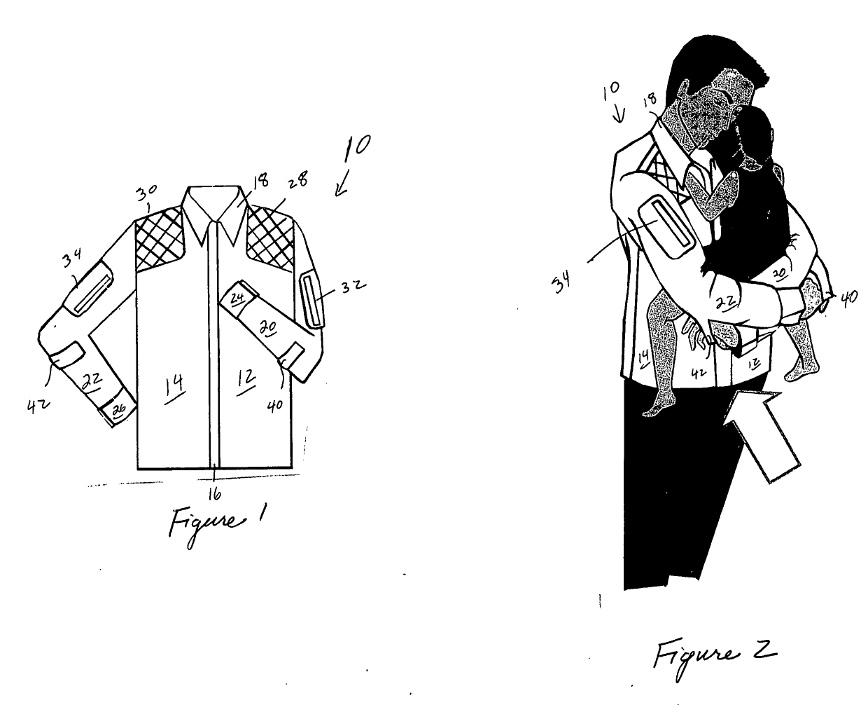

Referring now to the drawings in detail wherein like numerals refer to like elements throughout the several views, one see that article of clothing 10 is disclosed in FIG. 1 as a shirt, made of ordinary sturdy cloth material. Article of clothing 10 may be a shirt, blouse, jacket, coat or any similar article and typically has all of the elements thereof. Shirt 10 of FIG. 1 includes left and right (from the wearer's orientation) front panels 12, 14 which fasten together along a central area 16 with buttons or similar devices to engage or cover the chest area of the user. Shirt 10 further includes collar 18 and left and right sleeves 20, 22 with cuffs 24, 26. The shoulder areas optionally include quilted or padded areas 28, 30 for the baby or child to rest their head. The upper areas of left and right sleeves 20, 22 optionally include zippered storage compartments 32, 34.

Left and right sleeves 20, 22 include loops or straps 40, 42 sewn or similarly attached thereto immediately below the elbows, on the outer or rear portion of the sleeves 20, 22. As shown in FIG. 2, this allows the adult user to grasp strap 40 on left sleeve 20 with the right hand and to grasp strap 42 on right sleeve 22 with the left hand thereby supporting the child as shown and shifting the burden from the adult user's biceps to the triceps, hands and wrists.

Thus the several aforementioned objects and advantages are most effectively attained. Although preferred embodiments of the invention have been disclosed and described in detail herein, it should be understood that this invention is in no sense limited thereby and its scope is to be determined by that of the appended claims.

1. An article of clothing, including:
panels for engaging a chest area of a wearer;
first and second sleeves for covering arms of a wearer; and
first and second straps attached to a rear portion of said first and second sleeves, respectively, allowing a wearer to grasp said straps thereby allowing a wearer to hold a child.

2. The article of clothing of claim 1 wherein said first and second sleeves include respective first and second areas for covering elbows of a wearer, and wherein said first and second straps are situated immediately below said first and second areas.

3. (canceled)

4. The article of clothing of claim 1 wherein the article of clothing is configured and arranged for the wearer's hand extending from said first sleeve grasps said second strap and the wearer's hand extending from said second sleeve grasps said second strap.

5. The article of clothing of claim 1 wherein the article of clothing is selected from the group consisting of a shirt, a blouse, a jacket and a coat.
